(19) United States
(12) Patent Application Publication
(10) Pub. No.: US 2026/0036339 A1
(43) Pub. Date: Feb. 5, 2026

(54) RAIL SPLICE WITH INTERFERENCE FEATURES

(71) Applicant: PEGASUS SOLAR INC, Richmond, CA (US)

(72) Inventors: Erich Kai Stephan, Richmond, CA (US); Peter Wilke, Richmond, CA (US); Glenn Harris, Richmond, CA (US)

(21) Appl. No.: 19/355,874

(22) Filed: Oct. 10, 2025

Related U.S. Application Data
(62) Division of application No. 18/076,734, filed on Dec. 7, 2022.
(60) Provisional application No. 63/286,899, filed on Dec. 7, 2021.

(51) Int. Cl. F24S 25/65; E04B 1/24; E04C 3/04; H01R 4/2404; H01R 4/64; H02S 20/00

(52) U.S. Cl. CPC F24S 25/65; E04B 1/2403; H01R 4/2404; H01R 4/64; H02S 20/00; E04B 2001/2415; E04B 2001/2448; E04B 2001/2457; E04C 2003/0473

(57) ABSTRACT

A u-shaped splice that is used to connect two solar mounting rails, includes barbs that interact with the rails, requiring more force to remove the splice from the rails than the force required to insert the splice into the rails. Wedges, located at a mid-point between ends of the splice interact with the rails, creating an interference fit between the splice and the rails.

### CROSS-REFERENCE TO RELATED APPLICATION

This application is a divisional of U.S. patent application Ser. No. 18/076,734, filed on Dec. 7, 2022, entitled “RAIL SPLICE WITH INTERFERENCE FEATURES”, which claims the benefit of, and priority to, U.S. Provisional Patent Application No. 63/286,899, filed on Dec. 7, 2021, entitled “RAIL SPLICE WITH INTERFERENCE FEATURES”, the content of which is hereby expressly incorporated by reference in its entirety.

### BACKGROUND

Current rooftop solar arrays are supported using a series of beams, often called rails. These rails are connected using a splice; however, the splice can have a loose fit due to limitations in manufacturing, providing a sub-optimal installation experience. The present invention provides a way to create a rigid connection between two conjoining rails using a splice that can easily be manufactured with known techniques.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1A-1C depict views of a Splice;

FIG. 2 depicts a close-up view of a Barb;

FIG. 3A-3G depict a sequence of a Splice being installed into a Rail;

FIG. 4A-4D depict a sequence of a second Rail installing on a Splice;

FIGS. 5A and 5B depict a tool engaging with a Barb;

FIG. 6A-6D depict an alternative embodiment of Splice installing into Rail;

FIGS. 7A and 7B depict an alternative embodiment of Splice engaging with a Rail;

FIGS. 8A and 8B depict an end view of Splice in a set and flexed state;

FIG. 9A-9E depict views of an alternative Splice engaged with a Rail;

FIG. 10A-10C depict views of an alternative Splice engaged with a Rail and when a solar clamp is installed in a Rail;

FIG. 11A-11D depict views of an alternative embodiment of Splice with a groove and barbs pieces;

FIGS. 12A and 12B depict views of an alternative embodiment of the Splice installing with a Rail; and

FIG. 13A-13D depict a sequence of a Rail installing into a Rail Clamp.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

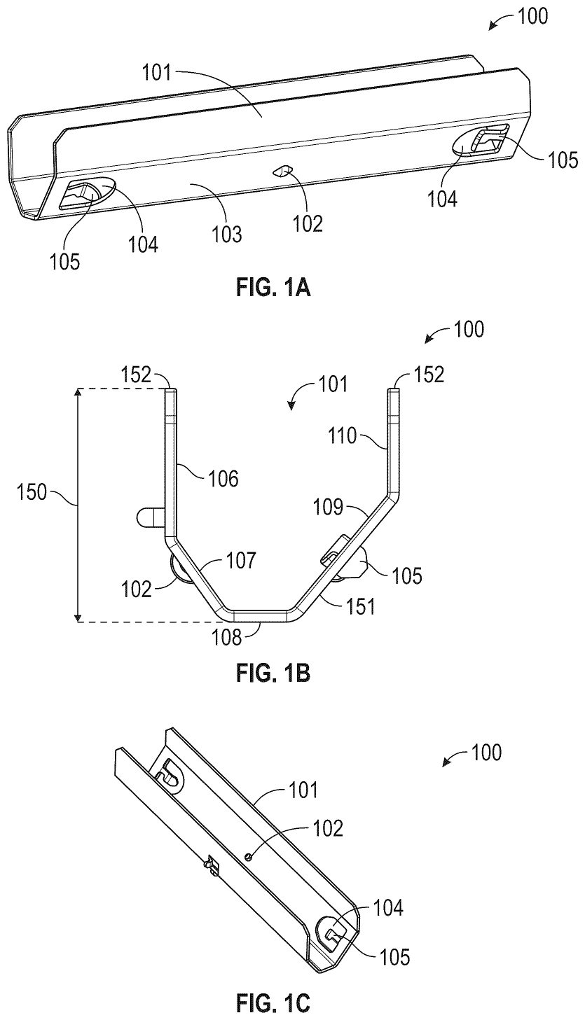

FIG. 1A depicts an isometric view representing an example embodiment of the present invention. The substantially u-shaped Splice 100 has Body 101 with an outward projecting central Wedge 102 protruding from an Angle Plane 103. One or more Apertures 104 located near the terminal or distal ends of the Body 101 may have an outward projecting Barb 105 with its point protruding away from the inside of the Body 101.

FIG. 1B depicts an end view of Splice 100, depicting the tips of Barb 105 protruding beyond the outer surface of Body 101. Wedge 102 is shown with a rounded outer surface and protruding beyond the outer surface of Body 101, although other geometries are contemplated, such as a pyramidal or rectangular shape. In this example embodiment, the Body 101 is comprised of a Left Vertical Wall 106, a Left Angled Wall 107, a Bottom Wall 108, a Right Angled Wall 109, and a Right Vertical Wall 110. Other shapes of Body 101 are contemplated, such as a Body 101 consisting of Left Vertical Wall 106, Bottom Wall 108, and Right Vertical Wall 110. In this example embodiment, the Barb 105 is located on the Right Angled Wall 109, though it could be located on any of the walls. In this example embodiment, Wedge 102 is located on the Left Angled Wall 106, though it could be located on any of the walls comprising the Body 101. The Splice Height 150 is the distance between the Splice Bottom 151 and Splice Top Edges 152.

FIG. 1C depicts an alternative isometric view of Splice 100. In this view, the interior indentation of Wedge 102 is visible.

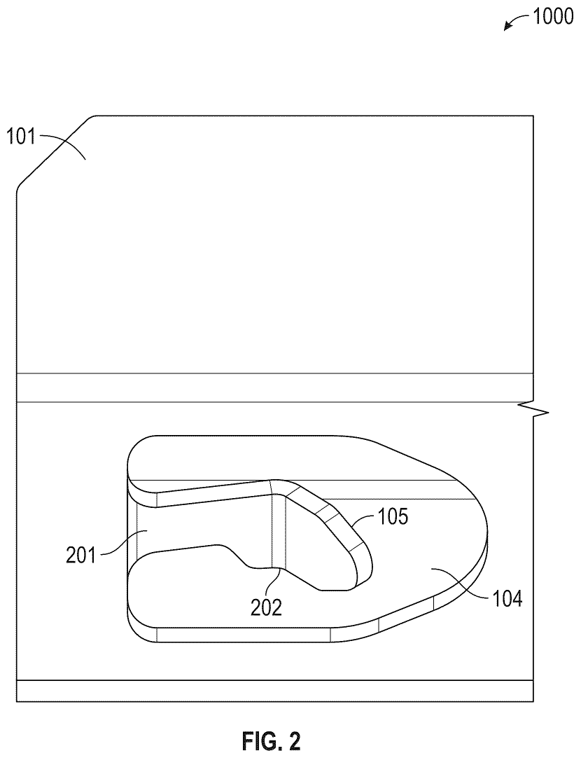

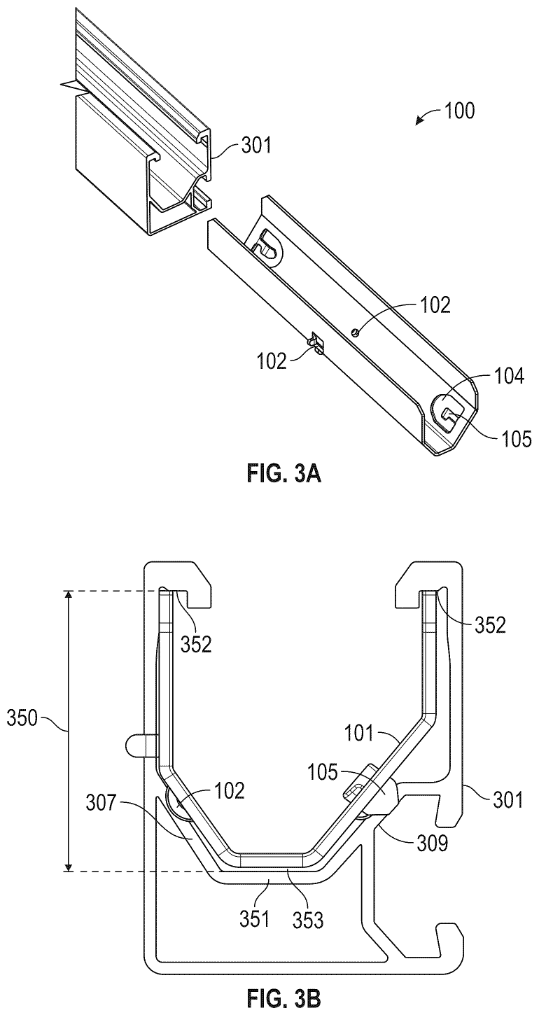

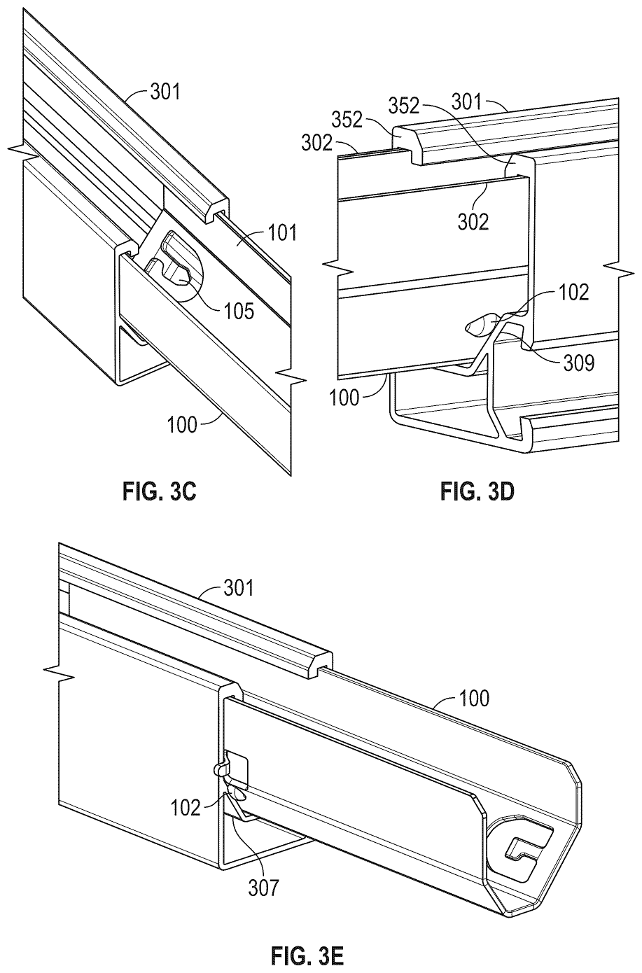

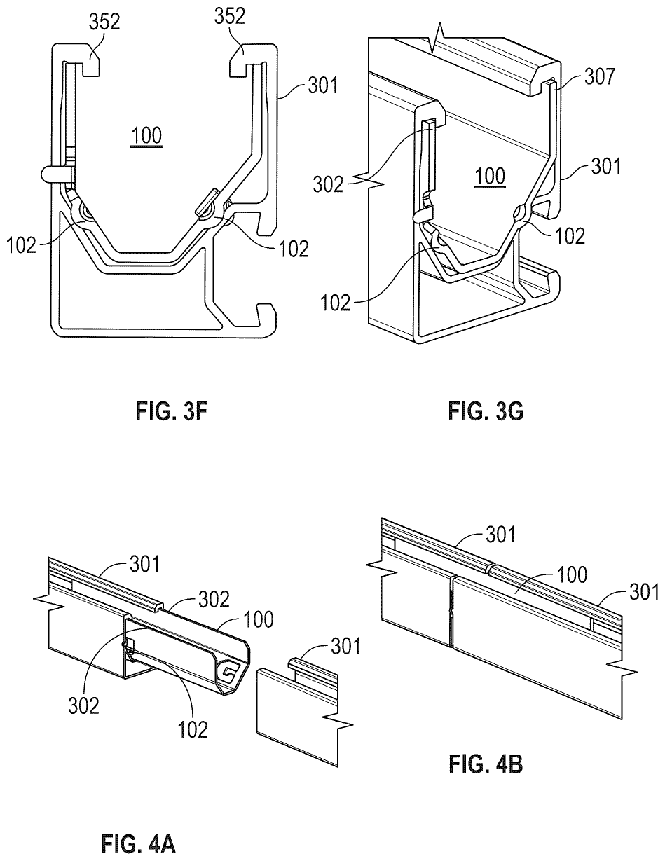

FIG. 2 depicts a close-up plan view of the Aperture 104 with Barb 105. The point of Barb 105 may have a rounded tip, as shown, or may be a sharp point or a flat point. Barb 105 may have a variable cross-sectional area, as shown, to allow for a desired force required to deflect the Barb 105 as it is inserted into a solar mounting Rail 301 (shown in FIG. 3). The Barb 105 may have a larger cross-sectional area towards the terminal end relative to the end emanating from the Body 101 in order to create a desired shape of the point (terminal end) of the Barb 105. The Aperture 104 may have an exterior shape that is generally an offset shape from the Barb 105, or if may have a different shape. The point of Barb 105 may have a point or edge sharp enough to pierce a coating of a Rail 301 in order to create an electrical bond path. The point of Barb 105 may also be sharp enough to readily prevent the Splice 100 from traversing out of the Rail 301 after the Splice 100 has been installed into the Rail 301. The Barb 105 may consist of one or more bends, wherein a First Barb Bend 201 forms the Barb 105 in towards the inside of the Body 101, and a Second Barb Bend 202 forms the terminal end of Barb 105 towards the exterior surface of the Body 101. The Second Barb Bend 202 may be at an angle such that the point of Barb 105 adequately pierces into an interior wall of Rail 301 such that the Splice 100 does not readily traverse back out of the Rail 301, i.e. in the direction opposite to which it was installed. In other words, the Barb 105 results in the force required to remove the Splice 100 from a Rail 301 to be greater than the force required to install the Splice 100 into a Rail 301. The Barb 105 may be positioned such that the planar face of the point creates an obtuse angle relative to the Body 101. This obtuse angle allows the point of Barb 105 to more easily slide into a terminal end of a Rail 301.

FIG. 3A-3G depict a sequence of the installation of Splice 100 into Rail 301, including both isometric, end, and cut-away views. Rail 301 has a generally u-shaped channel configured to receive a u-shaped Splice 100. FIG. 3A depicts a Splice 100 positioned in front of the terminal end of a Rail 301. FIG. 3B depicts an end view of FIG. 3A, where point of Barb 105 extends beyond the outside surface of Body 101 and overlaps with the interior surface of Rail 301. Splice Height 150 (in FIG. 1B) may be less that the Rail Interior Height 350 as measured between the Rail Interior Bottom 351 and Rail Grips 352, thereby leaving a Splice-Rail Gap 353.

FIG. 3C depicts a second step wherein Splice 100 has been initially inserted into the terminal end of Rail 301. The Barb 105 is engaged with an interior surface of Rail 301, and may be deflected towards the inside of Body 101. The force of the Barb 105 against the Rail 301 may be sufficient to pierce through a coating, such as a paint or anodization coating, in order to create an electrical bond path between the Splice 100 and Rail 301.

FIG. 3D depicts an isometric view demonstrating the inclined surface of a first Wedge 102 engaging with the inner edge of Right Angled Wall 309 of Rail 301. The Wedge 102 may be symmetric about the center plane of the Splice 100, as shown, or asymmetric. The angle face of Wedge 102 engages with the Right Angled Wall 309 to force the Splice 100 in the positive Z direction and compressing the Splice Top Edges 302 against the Rail Grips 352. When the Splice 100 is partially installed into Rail 301, the Splice 100 would be able to move up and down the Z axis by a distance equal to the Splice Rail Gap 353. When one or more Wedges 102 engage with the interior walls of Rail 301, an interference fit is created between Splice 100 and Rail 301, and as such the Splice 100 is restricted in the ability to move up and down the Z axis.

FIG. 3E depicts an isometric view of the opposing side as FIG. 3D, demonstrating a possible second Wedge 102 engaging with a Left Angled Wall 307 of Rail 301.

One or more Wedges 102 may be positioned on one or more walls of Splice 100 near the centerline or mid-point between the distal ends of Splice 100, as measured along the length of Splice 100. The Wedges 102 may have the same shape and dimensions, or different shapes and dimensions. In the example embodiment shown, the Wedge 102 has a diamond-shape when viewed perpendicular to the wall of the Splice 100 it is positioned on. In alternative embodiments, the Wedge 102 may have a square, oval, triangular, or other shape. The Wedge 102 may protrude a distance along its centerline and have an even slope towards each terminal or distal end. Alternatively, the Wedge 102 may have a curved slope from its centerline down to each terminal or distal end.

FIGS. 3F and 3G depict a cut-away end view of the Splice 100 installed into the Rail 301. In this embodiment, the Wedges 102 are demonstrated to have a uniform wall thickness. The Wedge 102 may have a substantially similar cross-sectional thickness of material as the Body 101, as shown.

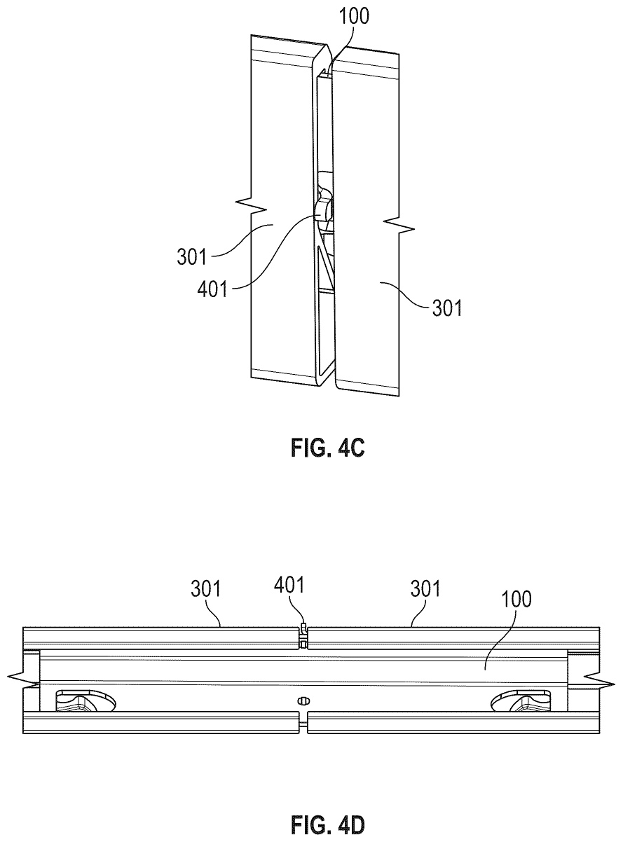

FIGS. 4A and 4B depict an isometric view of a second Rail 301 positioned in front of a second end of Splice 100. In FIG. 4B, a second Rail 301 is installed onto the Splice 100. The first and second Rails 301 may both engage the Wedges 102 on their respective sides. In this manner, the Wedges 102 engage with both a first and second Rail 301, pushing the Splice 100 in the upwards direction compressing the Splice Top Edges 302 against the Rail Grips 352. This effect creates the interference fit and a substantially more rigid connection between the first and second Rails compared to a Splice 100 without one or more Wedges 102.

FIG. 4C depicts a close up view where the first and second Rail 301 are fully installed onto a Splice 100. In this view, a Stop Tab 401 protrudes perpendicular to the Splice 100, preventing either Rail 301 from traversing further along the body of the Splice 100 as it is installed onto a Rail 301. FIG. 4D is a top-down view of the assembled Splice 100 in a first and second Rail 301.

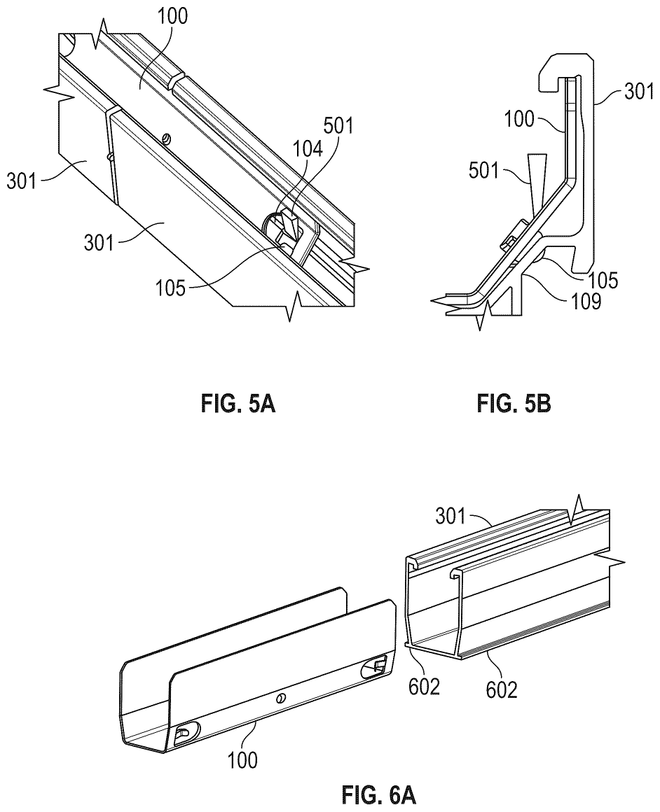

FIG. 5A is an isometric view of an installed Splice 100 into a first and second Rail 301, with a Tool 501 inserted between the outboard wall of Barb 105 and inside of Rail 301. The Tool 501 may be used to disengage the Barb 105 from the inside of Rail 301, such as on the Right Angled Wall 109 as shown. The Tool 501 may be a flat-head screwdriver, pliers, pry tool, metal wedge, or other similar tool. Shown in FIG. 5B., the distance between the Barb 105 and upper cut-out edge of Aperture 104 may provide sufficient clearance space to easily insert Tool 501 from above the top edge of Rail 301, or at an angle (not shown) relative to the shown vertical orientation. The Barb 105 may extend along the length Splice 100 a distance to adequately allow a Tool 501 to readily insert between the Barb 105 and Rail 301 as shown. The Barb 105 may engage with the Rail 301 to prevent the Splice 100 from manually being uninstalled from the Rail 301 along the opposite direction to which it was installed. Using a Tool 501, the Barb 105 could be deflected to disengaged from the Rail 301, thereby allowing the Splice 100 to readily uninstall from Rail 301 along the opposite direction to which it was installed.

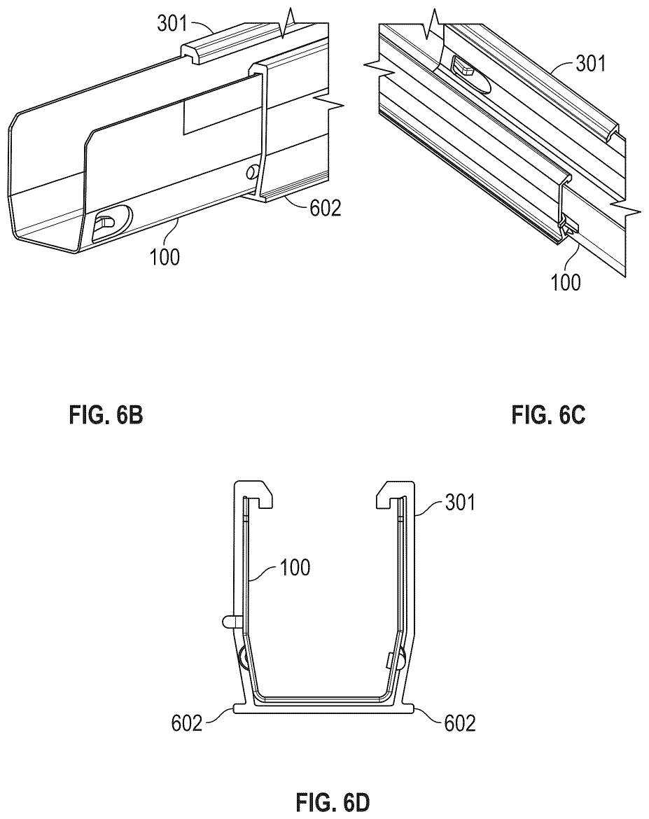

FIG. 6A-6D depict an alternative embodiment of the present invention whereby the Splice 100 and Rail 301 have less pronounced bends, and the Rail 301 has no hollow chamber. In this example embodiment, the Splice 100 is still substantially u-shaped, and the Rail 301 still has a substantially u-shaped channel configured to receive Splice 100. In this example embodiment, the Rail 301 may have opposing Rail Flanges or Exterior Protrusions 602 for attaching various components. Although not illustrated, Wedges may be located on all three faces of Splice 100.

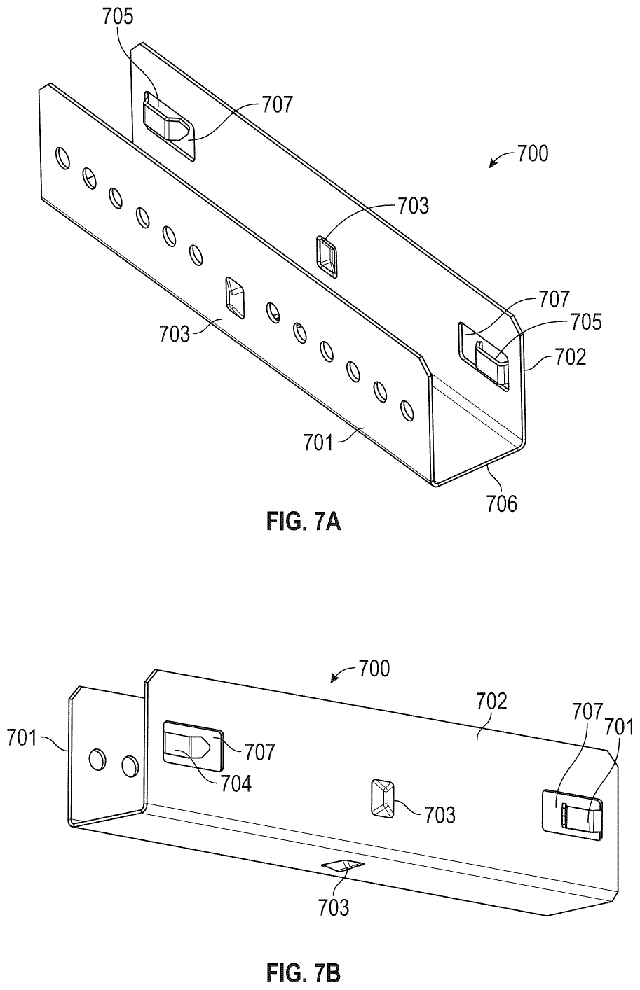

FIGS. 7A and 7B depict an alternative embodiment of the present invention where the Splice 700 has three substantially flat surfaces with two bends as opposed to five flat surfaces with four bends. In this example embodiment, the Splice 700 is still substantially u-shaped, and the rail still also has a substantially u-shaped channel configured to receive Splice 700. In this example embodiment, the Left Wall 701 and Right Wall 702 may be substantially parallel with one another, as shown, or may be angled slightly apart. Splice 700 may have one or more Wedges 703, including a Wedge 703 on all three surfaces. Wedge 703 is shown as a square pyramid shape, though other shapes are contemplated.

Barbs 704 may be formed to create a Barb Gap 705 between the outer wall of Barb 704 and inner wall of Splice 700 to readily insert a Tool 501. Splice 700 may have one or more Flex Apertures 707 along one or more walls (e.g. the Right Wall 702 as shown). The Flex Apertures 707 may be along the neutral axis, as shown, or further down the wall towards the bend between the Right Wall 702 and Bottom Wall 706 of the Splice 700. In some embodiments, the Flex Apertures 707 may cut through the bend formed between a Right Wall 702 and Bottom Wall 706, e.g., and the corner of the Splice 100.

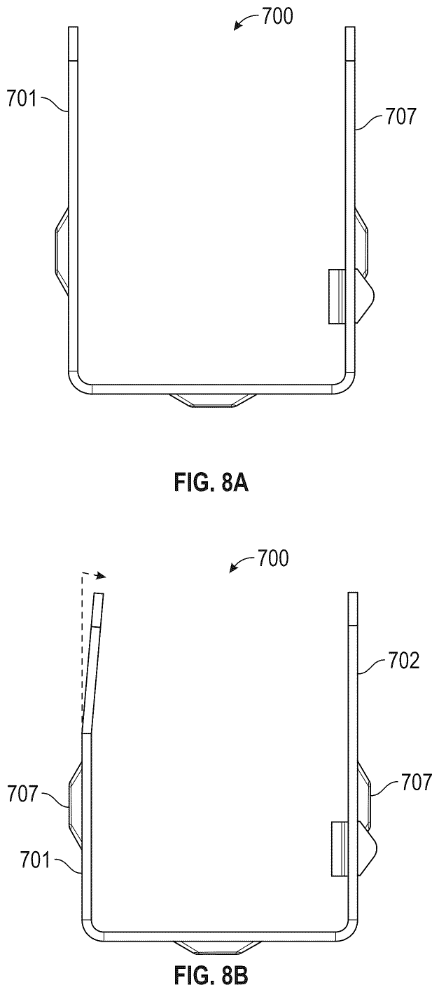

FIGS. 8A and 8B depict end views of Splice 700. Flex Apertures 707 may be spaced apart and have a size to meet a desired structural integrity, while reducing the stiffness to enable the Left Wall 701 and Right Wall 702 to be compressed together or pulled apart by manual action, such as with a person's hand. In FIG. 8A, the Splice 700 is in its nominal state. In FIG. 8B, the Left Wall 701 is temporarily bent inwards towards the Right Wall 702 along position of the Flex Apertures 707. The Splice 700 may be made of a material, such as Aluminum or Stainless Steel, to allow for the Left Wall 701 to bend towards the Right Wall 702 along the Flex Apertures 707 without being permanently deformed. After the force applied to the Left Wall 701 is removed, the Left Wall 701 may substantially spring back to its original, permanent position shown in FIG. 8A.

In an alternative embodiment not shown, one or both of the Left Wall 701 and/or Right Wall 702 may be at an obtuse angle to the Bottom Wall 706. In this alternative embodiment, the Left Wall 701 and Right Wall 702 may be temporarily compressed together, such as by hand, to be substantially parallel to one another for installation into the Rail 301. Upon releasing the walls of the Splice 700, the Left Wall 701 and Right Wall 702 may outwardly compress against the inner walls of Rail 301, thereby creating a tighter fit between the Splice 700 and Rail 301.

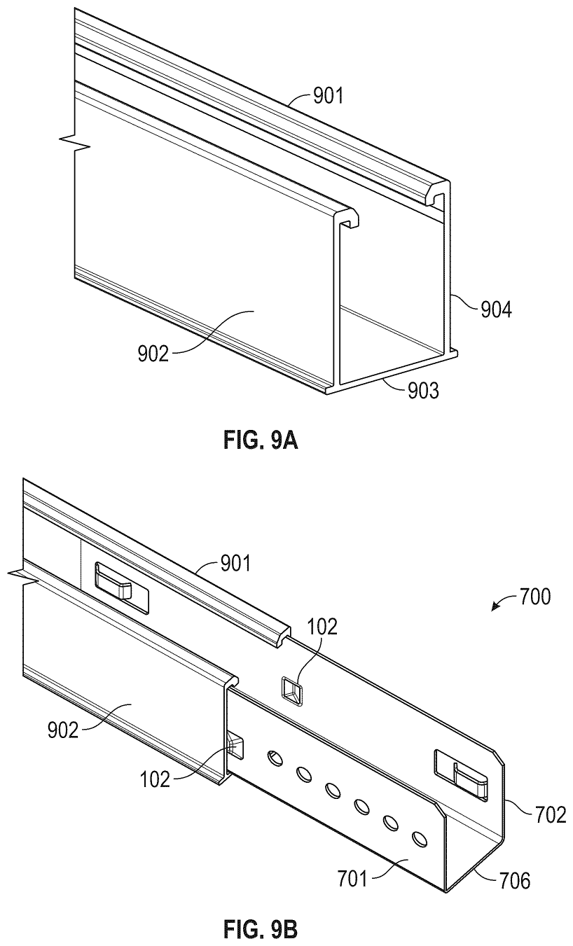

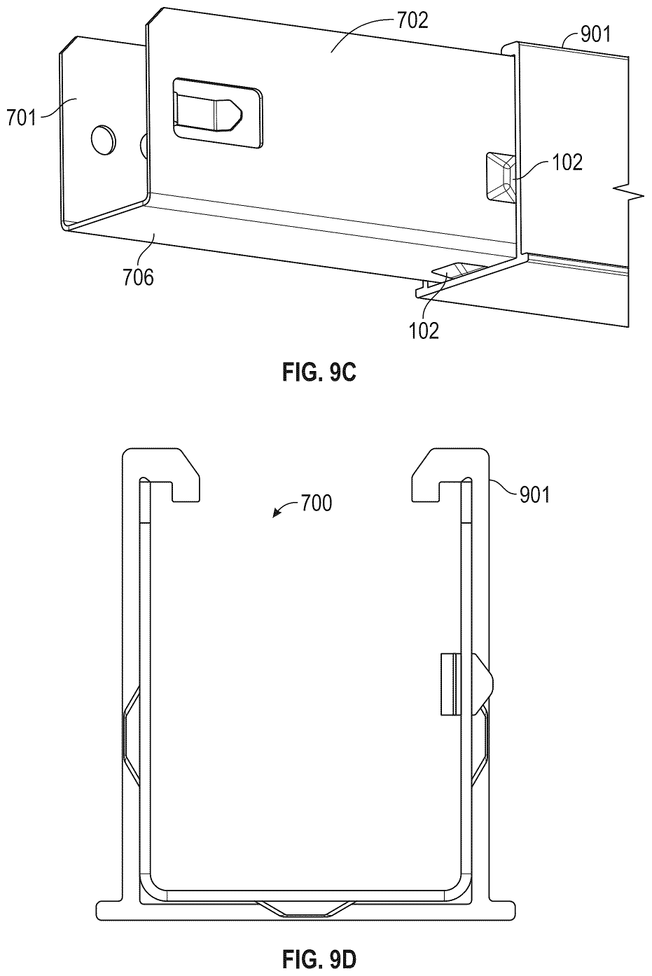

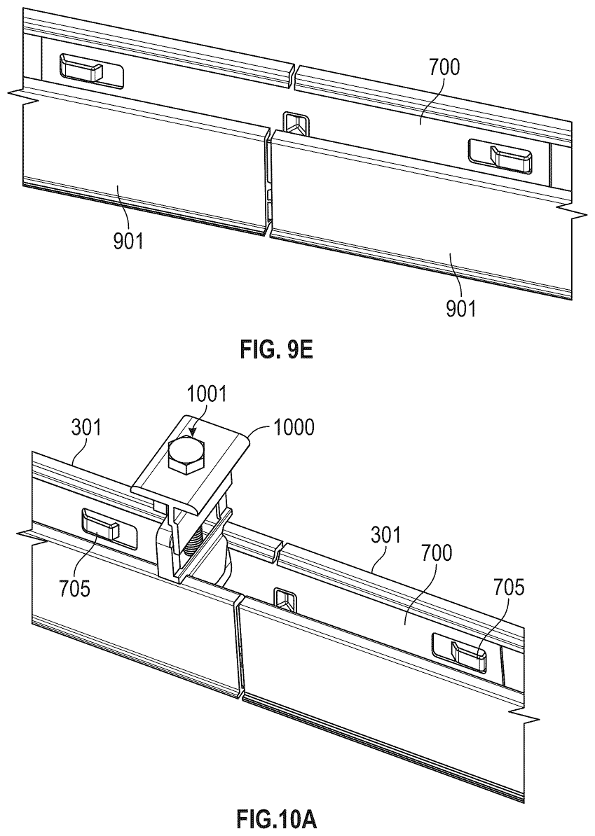

FIGS. 9A through 9E depict a Square Rail 901 engaging with Splice 700. FIG. 9A depicts a Square Rail 901 with a Left Wall 902, Bottom Wall 903, and Right Wall 904. As shown in FIG. 9A, each wall of Square Rail 901 is substantially flat, but in other embodiments not shown, each wall may have a curvature shape to improve resistance against buckling. FIG. 9B depicts the Splice 700 fully installed in a first Square Rail 901 with Wedge 102 engaging with the end surface of Square Rail 901. Splice 700 may have a Wedge 102 on a Left Wall 701, Right Wall 702 and Bottom Wall 706 that substantially simultaneously engage with the end surface of Square Rail 901 when the Splice 700 is inserted a distance into Square Rail 901. Upon engagement, the one or more Wedges 102 may force the Splice 700 to compress against the opposite surfaces of each respective Wedge 102 into the Square Rail 901 in order to create a snug interference fit.

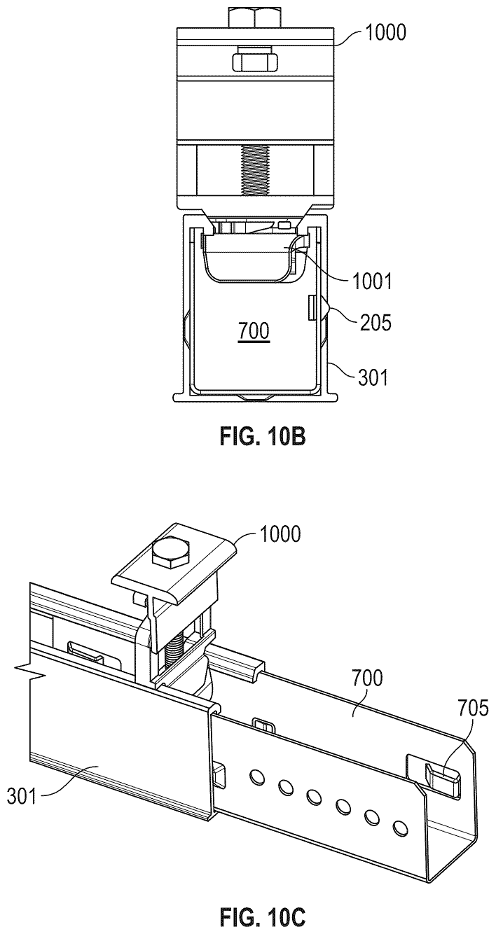

FIG. 10A depicts a first Splice 700 installed into a first and second Rail 301, with a Clamp 1000 installed into a Rail 301. The Clamp 1000 may be installed into a Rail 301 over the location of a Splice 700, or into a section of Rail 301 without a Splice 100. The Clamp 1000 may have a plate that engages to the Rail 301 for securement, and Barbs 705 may be positioned below the top surface of Rail 301 so that said nut and Barbs 705 do not interfere when the Clamp 1000 is installed into Rail 301.

FIG. 10B depicts an end view of FIG. 10A where a first Splice 700 installed into a first and second Rail 301, with a Clamp 1000 installed into a Rail 301. As illustrated, a width of the Clamp Nut 1001 is greater than a width of the opening of Rail 301. Also as illustrated, a width of the Clamp Nut 1001 is less than a width of the opening of Splice 700. In this example embodiment, the Clamp Nut 1001 resides between the walls of the Splice 100. The Barbs 705 are located below the Clamp Nut 1001 a distance sufficient to not interfere with the Clamp Nut 1001 when it is installed and during the installation process of the Clamp 1000. FIG. 10C depicts FIG. 10A without a second Rail 301 installed.

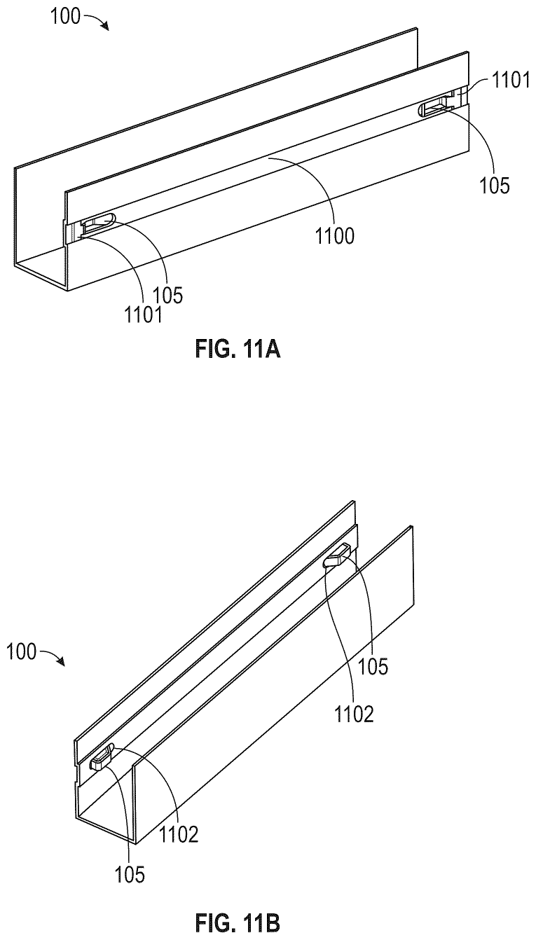

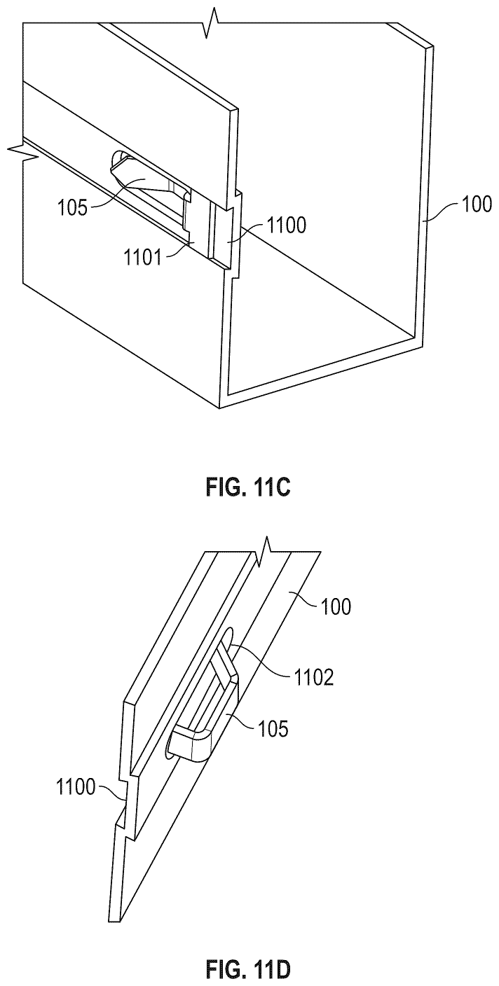

FIGS. 11A through 11D depict an alternative embodiment of the present invention where the Barbs 105 are a separate, installed component into the Splice 100. In this example embodiment, the Splice 100 may have an extruded Groove 1100 on one or more surfaces that is used to help capture a Barb Piece 1101. The Barb Piece 1101 may have flanges that engage with Groove 1100 to hold Barb Piece 1101 in place. One or more Apertures 1102 may be in the Groove 1100 as shown, or generally positioned on a wall of the Splice 100 to allow the Barb Piece 1101 to traverse through the Splice 100. Barb Piece 1101 may traverse through the Splice 100 to present a sharp point that would engage the interior wall of a Rail 301, while also presenting a surface for a Tool to readily be inserted from the inside area of Splice 100 to disengage the Barb Piece 1101 from the interior wall of Rail 301. The Barb Piece 1101 may engage the Rail 301 in much the same way as previously discussed, namely to pierce the coating on a Rail 301 to create an electrical bond connection, and/or to prevent the Splice 100 from readily uninstalled out of a Rail 301 after the Splice 100 has been installed onto a Rail 301.

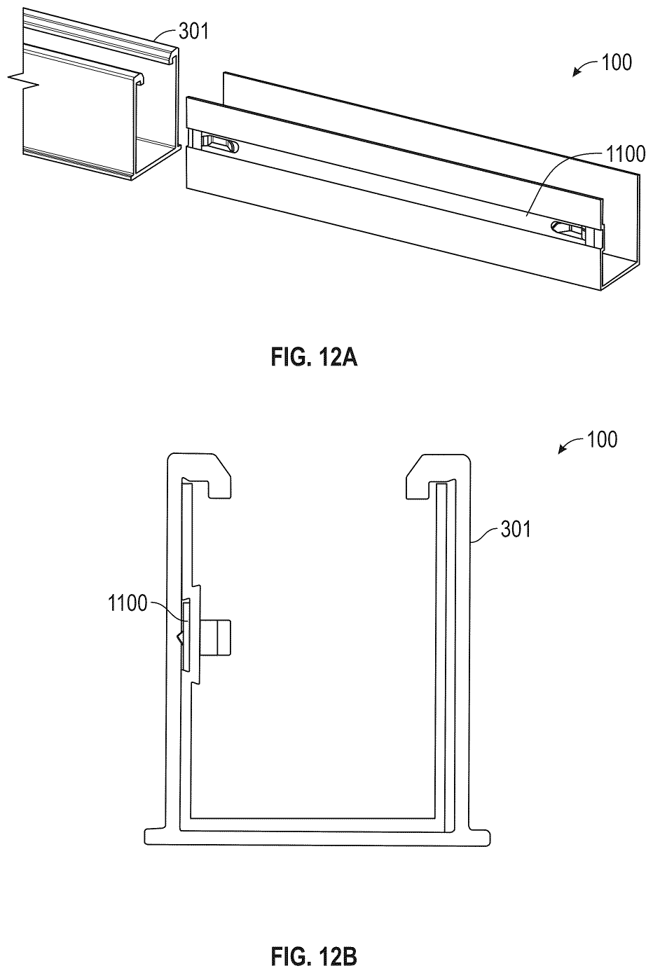

FIG. 12A depicts an isometric view of a Splice 100 installing into a first Rail 301. FIG. 12B depicts an end view of the Splice 100 installed into a Rail 301. In this example embodiment, the Groove 1100 is formed to the interior direction of the outer wall of the Splice 100.

In an alternative embodiment not shown, a Splice 100 may have a Wedge Piece installed near the mid-point down the length of the Splice 100. The Wedge Piece may be a separate part that is added to the Splice 100 in an assembly operation. The Splice 100 may have an aperture through which the Wedge Piece traverses to secure with the Splice 100. The Wedge Piece may have a C-shaped mouth with barbs or teeth that bite into the Splice 100 during assembly in order to prevent dis-assembly. The Wedge Piece may have an incline plane relative to the wall of the body of the splice, which acts as a wedge between the Splice 100 and Rail 301 upon the Splice 100 being installed into the Rail 301. The Wedge Piece may also have a spike feature, and be made of a material with a sufficient hardness to pierce the coating of a Rail 301, such as an anodized coating, to form an electrical bond path.

In an alternative embodiment not shown, Splice 100 may also have one or more protrusions along the top edge of the Splice 100 that provides a compressive force against the underside of Rail Grips 352. The protrusions may have a curved form, like a leaf-spring, and angled to readily slide into a Rail while providing sufficient compressive force against the Rail Grips 352. The protrusions may be formed from the Body 101, or may be a separate piece that is assembled to the Splice 100.

Splice 100 may be manufactured from aluminum, steel, stainless steel, a polymer, or other suitable material. The Splice 100 may be manufactured from a uniform thickness sheet of metal, such as sheet metal, wherein all features and protrusions have substantially similar material thickness. Alternatively, the Splice 100 may be manufactured from an aluminum extrusion, where the cross-sectional geometry is uniform for the length of the Splice 100, except for apertures or bent flanges created as a secondary manufacturing operation. The Splice 100 may be of a material with a greater hardness than a coating on the Rail 301, such a coating could be anodization or paint or powder coating. The Splice 100 may have a material thickness and material properties such that the strength of the Splice 100 is substantially similar to the strength of the Rail 301. The Splice 100 may be manufactured using station dies, a break press, progressive die stamping, extrusion, punching, or other similar processes.

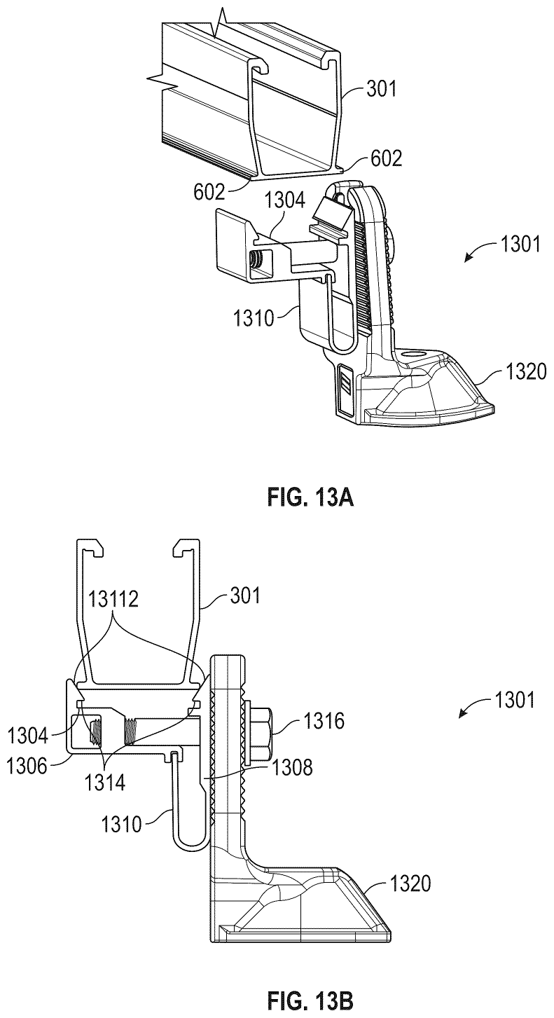

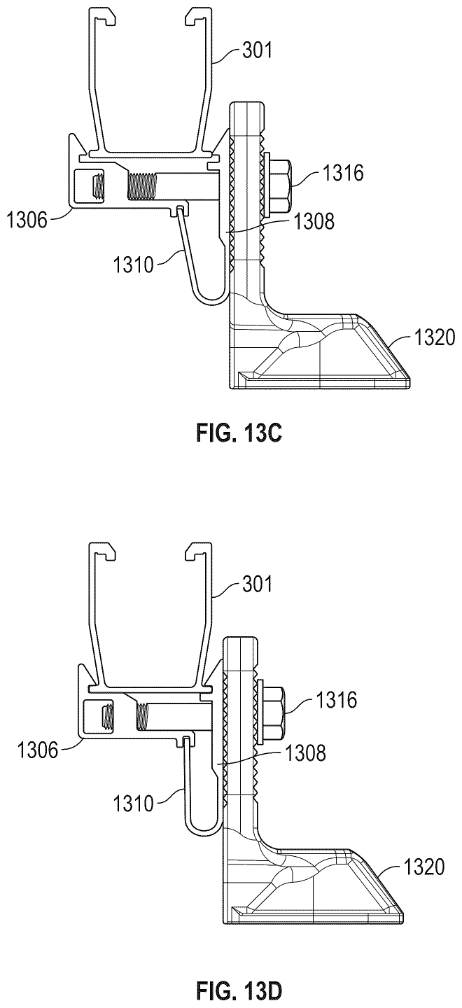

FIGS. 13A through 13D depict an installation sequence of a Rail 301 attaching to a Rail Clamp 1301. Rail 301 has a substantially u-shaped channel configured to receive a substantially u-shaped Splice 100 similar to that shown in the previous Figures. Rail 301 has Rail Flanges 602 which extend laterally from either side of the Rail 301 away from the center of Rail 301. Rail Flanges 602 may be substantially rectangular as shown, or may be tapered. The Rail Flanges 602 may be dimensioned to loosely fit within the Grooves 1304, or have tapered surfaces to create a jam-fit when the Arm Grip 1306 and Base Grip 1308 are compressed onto one another. The Rail Flanges 602 may protrude from an undercut space so the outside edge is substantially co-planar with the outside walls of the Rail 301, as shown. Rail Clamp 1301 may be constructed to two parts, each having a uniform cross-sectional geometry along their lengths, except for one or more apertures disposed laterally across their length.

FIG. 13A depicts an isometric view of Rail Clamp 1301 attached onto a Roof Attachment 1320. Rail 301 is positioned above the Rail Clamp 1301, and the Flange Spring 1310 is in a nominal state. FIG. 13B depicts an end view of the next step, wherein the Rail 301 rests on the Incline Surfaces 1312 on the Barb Features 1314 that form above the pair of Grooves 1304. A downward pressure on the Rail 301 results into a lateral force on the Incline Surfaces 1312, forcing the Arm Grip 1306 to traverse laterally away from the Base Grip 1308 along the length of the Fastener 1316. This action creates a tensile force in the Flange Spring 1310. In FIG. 13D, the Rail 301 has been pushed down far enough such that the Rail Flanges 602 are level with the Grooves 1304, and the tensile force in the Flange Spring 1310 pulls the Arm Grip 1306 back along the length of the Fastener 1316 to capture the Rail Flanges 602 within the Grooves 1304. When the Rail Flanges 602 reside in the Grooves 1304, the Flange Spring 1310 may be in a nominal state, or in a slight tensile state in order to apply a desired lateral compression between the Arm Grip 1306 and Base Grip 1308 onto Rail Flanges 602. The Flange Spring 1310 may be shaped and dimensioned to allow the Rail 301 to slide through the Rail Clamp 1301 with moderate hand pressure (i.e. into an out of the page in FIG. 13C) while providing a desired level of friction to resist readily sliding. Once the Rail 301 is in its desired position, the Fastener 1316 may be tightened to secure the Rail 301 to the Rail Clamp 1301 and Roof Attachment 1320.

What is claimed is:

1. A method for installing a substantially u-shaped splice into a rail comprising:
inserting the splice a first distance into the rail using a first force, wherein at least one outward projecting barb that is formed in the splice initially contacts the rail at the first distance; and
applying a second force greater than the first force to insert the splice a second distance into the rail, wherein at least one outward projecting wedge that is formed in a wall of the splice initially contacts the rail at the second distance.

2. The method of claim 1, further comprising removing the splice from the rail by applying a third force, wherein the third force is greater than the second force, based at least on an interaction between the at least one outward projecting barb and the rail.

3. The method of claim 1, wherein inserting the splice the second distance into the rail causes the at least one outward projecting barb to pierce a coating on the rail, creating an electrical bond path between the splice and the rail.

4. The method of claim 1, wherein the at least one outward projecting wedge applies a force in a positive z-direction to compress one or more top edges of the splice against one or more grips of the rail.

5. The method of claim 4, wherein the at least one outward projecting wedge creates an interference fit between the splice and the rail to prevent movement in the z-direction.

6. The method of claim 1, wherein the splice is made of a material that is harder than a surface of the rail.

7. The method of claim 1, wherein inserting the splice includes inserting the splice having a uniform wall thickness.

8. The method of claim 1, wherein the at least one outward projecting wedge is located substantially at a mid-point between a first distal end and a second distal end of the splice.

9. The method of claim 1, wherein inserting the splice by the second distance includes engaging an inner edge of the rail by a surface of the at least one outward projecting wedge.

10. The method of claim 1, wherein the outward projecting barb has a variable cross-sectional area.

11. The method of claim 10, wherein the outward projecting barb includes a proximal end and a terminal end, wherein a cross section of the barb at the terminal end is larger than a cross section of the barb at the proximal end.

12. The method of claim 1, wherein a height of the splice is less than a height of an interior surface of the rail.

13. The method of claim 1, further comprising applying a third force to insert a second distal end of the splice into a second rail, wherein the at least one outward projecting wedge engages both the rail and the second rail.
